(19) United States
(12) Patent Application Publication
(10) Pub. No.: US 2012/0295702 A1
(43) Pub. Date: Nov. 22, 2012

(54) OPTIONAL ANIMATION SEQUENCES FOR CHARACTER USAGE IN A VIDEO GAME

(76) Inventors: Joby R. Otero, Santa Monica, CA (US); Vincente Castillo, JR., Novato, CA (US)

(21) Appl. No.: 13/109,943

(22) Filed: May 17, 2011

(51) Int. Cl. G06F 17/00

(52) U.S. Cl. 463/31; 463/42; 463/43

(57) ABSTRACT

A video game includes user selectable animation routines for a game character. The animation routines may be performed by the game character upon entry to game play, upon occurrence of predefined game events, or as commanded by a game player. Information of the animation routines may be downloaded from a server to a game machine, and available animation routines may be limited based on information relating to the game character.

### BACKGROUND OF THE INVENTION

The present invention relates generally to video games, and more particularly to user selectable video game character animation routines.

Video games provide enjoyment for many. Video games allow game players to participate in a variety of simulated activities, including those that the game players may not be able or desire to experience directly, whether due to cost, danger, or equipment concerns, or simply due to the activity or its surroundings being in the realm of fantasy.

Video games often provide game players the opportunity to control movement of a video game character, at least to some extent. The control, however, is often necessarily limited. Video game control apparatus often only provide for a limited number of inputs, and the ranges of those inputs are often also limited. In addition, the ability of a game player to control the inputs also may be limited by physical constraints of the game player, with the game player being physically limited in velocity and extent of contortion of their own body. In the case of a motion detection controller, the limitations of the human body necessarily impose limitations on detected movements and speed of those movements. For example, in the case of handheld video game controllers, generally a game player is only physically capable of manipulating a limited number of input devices at a single time. Moreover, the supported range of movement of a video game character may also be limited, for example to movements expected to occur during play of the video game.

Limitation of control of movements of video game characters, in turn, results in decreased freedom of game players to personalize or provide more unique characteristics to a video game character. As video game players may, to an extent, identify themselves with the game characters, or otherwise form a relationship of sorts with the video game character, an inability to personalize the video game character may detract from overall enjoyment of the video game.

### BRIEF SUMMARY OF THE INVENTION

In aspects the invention provides game player selectable video game animation routines.

One aspect of the invention provides a computer implemented method of providing user selectable animation routines for use in video game play, comprising: receiving, over a data network, video game character related information regarding a video game character played by a game player; determining available animation routines based on the video game character related information; and transmitting, over the data network, information of at least one of the available animation routines.

Another aspect of the invention provides machine readable media for a video game, the machine readable media including program instructions for execution by at least one processor, the program instructions including program instructions for: providing for video game play relating to at least one game character; transmitting a request for an animation routine for the game character; storing received information of an animation routine for the game character; and commanding display of the animation routine for the game character.

These and other aspects of the invention are more fully comprehended upon study of this disclosure.

### BRIEF DESCRIPTION OF THE FIGURES

FIG. 1 is an example of a video game system in accordance with aspects of the invention;

FIG. 2 is an example block diagram of video game console in accordance with aspects of the invention;

FIG. 3 is a flowchart of a process for obtaining information of an animation routine in accordance with aspects of the invention;

FIG. 4 is a flowchart of a process for determining a selected animation routine in accordance with aspects of the invention;

FIG. 5 is a flowchart of a process for displaying a selected animation routine in accordance with aspects of the invention;

FIG. 6 is a flowchart of a further process for displaying a selected animation routine in accordance with aspects of the invention;

FIG. 7 is a flowchart of a further process for displaying a selected animation routine in accordance with aspects of the invention;

FIG. 8 is a block diagram of a network used in providing animation routine information in accordance with aspects of the invention;

FIG. 9 is a flowchart of a process for providing animation routine information over a network in accordance with aspects of the invention; and

FIG. 10 is a flowchart of a process for determining available animation routines in accordance with aspects of the invention.

### DETAILED DESCRIPTION

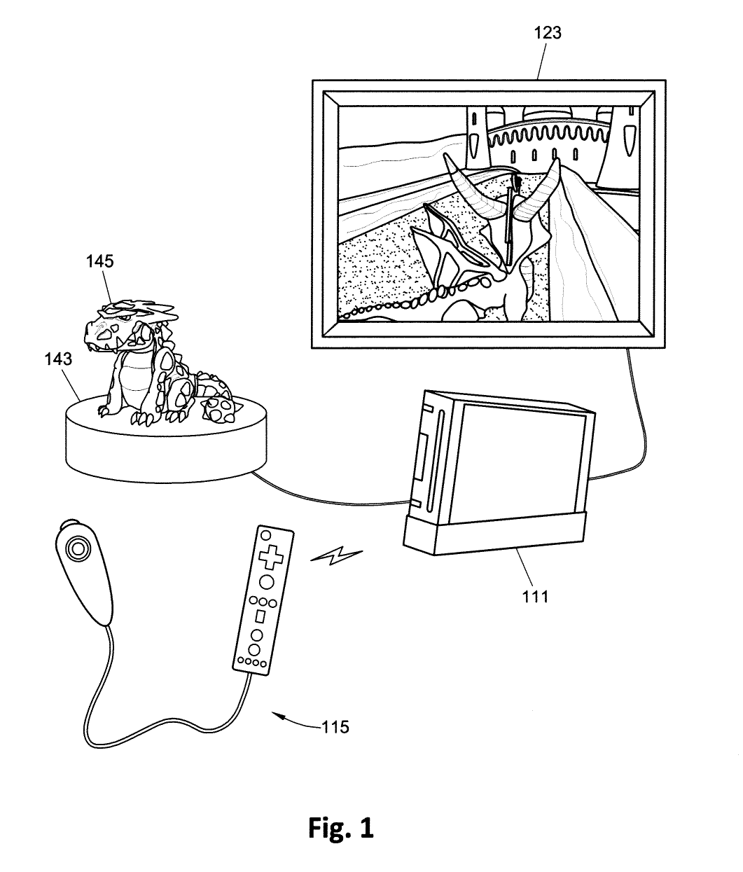

FIG. 1 is an example of a video game system in accordance with aspects of the invention. The video game system includes a video game console 111 with a processor for executing program instructions providing for game play, user input devices such as a video game controller 115, a display device 123, and a reader 143. The processor, responsive to inputs from the user input devices and in some embodiments the reader, generally commands display on the display device of game characters in and interacting with a virtual world of game play and possibly each other.

The instructions providing for game play are generally stored on removable media, for example, an optical disk. Accordingly, the game console may include an optical drive, for example, a DVD-ROM drive, for reading the instructions for game play. In some embodiments, the game console may be instead a personal computer, or a notebook or netbook computer, including, in some instances, a built-in display and built-in or attached user input devices.

The reader, in some embodiments and as shown in FIG. 1, has a substantial a upper surface for placement of an object thereon. The game player generally places game objects, for example a toy figure 145, on the flat surface of the reader during game play. In many cases the toy figure is in the form of and representative of a game character of the game, for example the dragon of FIG. 1. In most embodiments, while the toy figure is placed on the reader the game console may, through the receipt of user inputs for example, allow for control of the game character during game play.

The toy figure includes a machine-readable information, for example a radio frequency identification (RFID) tag or a bar code. The reader generally includes reader circuitry, for example RFID reader circuitry, bar code reader circuitry, or other reader circuitry, processing circuitry in some embodiments, and communication transmitter or transceiver circuitry. The reader circuitry detects the presence of a machine readable information on or about the reader. The processing circuitry may execute instructions according to firmware that is also stored in the reader. The processing circuitry may control operation of the reader circuitry, and also process signals from the RFID reader to determine data to be sent to the game console. The communication transceiver included in the reader sends reader data to the game console. The communication transceiver may send data, for example as controlled by the processing circuitry.

The display device is generally coupled to the game console by a cable, although in some embodiments a wireless connection may be used. In many embodiments, the display device is a liquid crystal display. In some embodiments, the display device is a television. A display screen 131 of the display device displays video images of game play, generally as commanded by the processor or other associated circuitry of the game console. In the embodiment of FIG. 1, the display screen shows a screen shot of video game play. As illustrated, the screen shot shows a display of a character, generally controlled by and animated in accordance with user inputs, approaching what may be considered a castle.

As previously indicated, included in or on the toy figure is machine-readable information, for example an RFID tag, that may be sensed or read by the reader. The machine-readable information may include an identifier identifying the game character. The machine-readable information allows the reader, or the processor of the game console, to distinguish one toy figure from other toy figures, and the machine-readable information may also include information relating to a variety of aspects of the game character. For example the machine readable information, which in some embodiments is also writeable, may include information relating to a level of the game character, items in the game characters possession, items worn by the game character, an owner of the game character, and other matters. In some embodiments each particular toy figure may have its own separate identifier, for example two otherwise identical toy figures may each have a unique identifier. In some embodiments, however, identical game objects may have the same identifier, and in other embodiments similar game objects may have the same identifier.

When information of a toy figure is read by the reader, the reader provides the game console an indication of the identity of the toy figure, and generally the processor of the game console commands display of a corresponding game character or otherwise makes the corresponding game character or item available in game play. For example, when a toy figure, such as the dragon of FIG. 1, is placed on the reader, a corresponding game character, generally animated by game player inputs, may appear in the game, and in some embodiments remain in the game so long as the toy figure is on the reader. During game play the game player generally controls the game character, and causes the game character to move about a game defined world, undertaking various adventures and performing various tasks, with game play displayed on the display. In some embodiments the processor may cause placement of the game character in a predefined location or any one of several predefined locations, based, for example, on predefined selection criteria.

In some embodiments the game console commands display of a user selectable animation routine upon appearance of the game character in the game. For example, placement of the toy figure on the reader may result in the corresponding game character appearing in the game, and upon appearance of the game character may perform a dance or other movements or gestures specified by the animation routine. In some embodiments the game console also commands generation of audio, which in some embodiments may be user selectable audio, to accompany display of the animation routine.

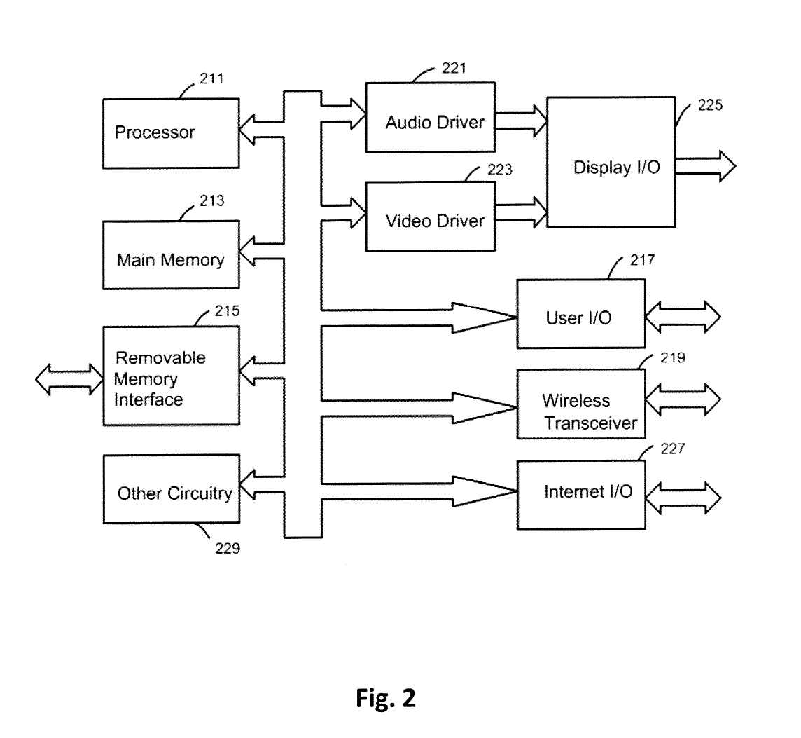

FIG. 2 is an example of a block diagram of a processor and associated circuitry, for example for a game console, useful in accordance with aspects of the invention. As shown in FIG. 2 a processor 211 is connected to other components via a bus. The other components include a main memory 213 and a removable memory interface 215 generally coupled to a removable memory device, for example, a DVD-ROM drive. The processor may execute instructions from the removable memory device to control game play and store game state information in the main memory. For example, the instructions may be for determining possible movements, positions, and locations of the game character.

The processor is coupled to an audio driver 221 and a video driver 223. The audio driver produces sound signals and the video driver produces image signals. The sound signals and image signals are transmitted from the personal computer via a display I/O device 225. The display I/O device generally supplies the sound and image signals to a display device external to the personal computer.

The processor may also be coupled to a user I/O device 217, a wireless transceiver 219, an Internet I/O device 227, and other circuitry 229. The user I/O device may receive signals from an RF reader and/or signals from a keyboard, a mouse, and/or a game controller, with generally the keyboard, mouse, and/or controller being used by a user and providing user inputs, for example during game play. Alternatively or additionally, the personal computer may receive user inputs via the wireless transceiver. The Internet I/O device provides a communication channel that may be used, for example, for multiple player games.

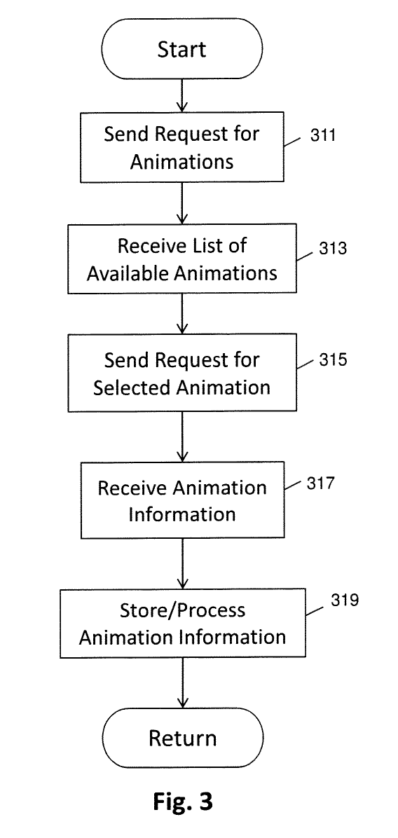

FIG. 3 is a flowchart of a process for receiving animation routine information in accordance with aspects of the invention. The process of FIG. 3 may be performed, for example, by the game console of FIG. 1 or the processor, in conjunction with circuitry generally associated with processors in a networked environment, of FIG. 2.

In block 311 the process transmits a request for animation routines to another computer unit, one available over for example the Internet in many embodiments. In some embodiments the request simply is a request for animation routines, with information of the request for example including an indication of a request for animation routines and additional information normally provided with communications between computer units, for example an identification of the requesting computer unit. In some embodiments the request additionally includes information indicating a particular character for which the animation routine is intended. In various embodiments the request may also indicate information regarding the status of the game character, for example a level of the game character, or items associated with the game character, such as items in the control of the game character or worn by the game character, which in some embodiments may be also considered as included in the status of the game character.

In block 313 the process receives an indication of available animation routines. The indication of available animation routines may be a list of available animation routines in some embodiments, and in some embodiments the indication of available animation routines may include information for providing a preview, full or partial, of the available animation routines. In such embodiments the processor will generally command display to the game player, by way of list or preview, of the available animation routines. In some embodiments the available animation routines may be already present in memory available to for example a processor performing the process, and the indication of available animation routines may be information sufficient for the processor to determine which animation routines are available, but not yet useable by the game player. In such embodiments the processor may thereafter command display of the available animation routines to the game player.

In block 315 the process transmits a request for a selected animation routine. In most embodiments the process receives, via a game player input, an indication of the selected animation routine for use in the request.

In block 317 the process receives animation routine information for the selected animation routine. In many embodiments the animation routine information is information to be used in generating a display of the selected animation routine. In some embodiments the animation routine is a key or other information allowing for unlocking for use animation routine information already available to, for example, a processor performing the process of FIG. 3.

In block 319 the process stores the animation routine information in memory.

The process thereafter returns.

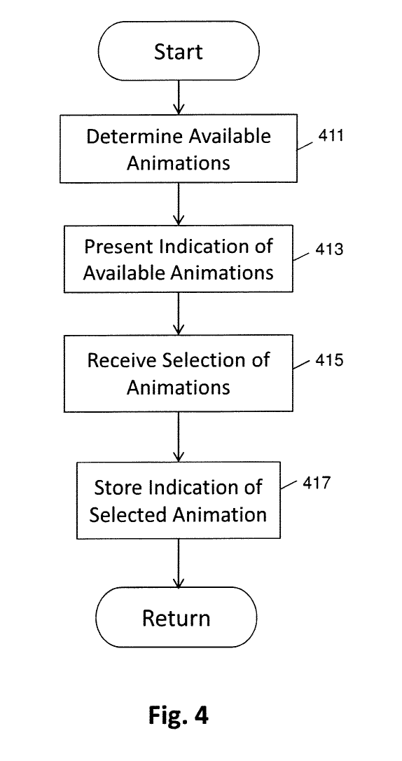

FIG. 4 is a flowchart of a process for selecting an animation routine for use during game play. The process of FIG. 4 may be performed, for example, by the game console of FIG. 1 or the processor, in conjunction with associated circuitry, of FIG. 2.

In block 411 the process determines available animation routines. In some embodiments only a single animation routine may be available, or in some embodiments only a single animation routine with corresponding accompanying audio may be available, in which case the process simply selects the single animation routine, or single animation routine and corresponding accompanying audio, and skips the remainder of the process of FIG. 4. In some embodiments multiple animation routines may be available, with the information of available animation routines being stored in memory available to, for example, a processor performing the process of FIG. 4. Similarly, in some embodiments multiple different accompanying audio may be available, either in total or for one or all of the animation routines, with information of the accompanying audio also stored in the memory.

In some embodiments the available animation routines and/or available accompanying audio are user or game player generated, or based on user or game player input. For example, in some embodiments user inputs may be used in forming an animation routine. In some embodiments a game unit determines a sequence of character motions based on user inputs, provided by way of a game controller, which may include an imaging device, and stores information of the sequence of motions in memory. The sequence of motions may then be selected as an animation routine, or provided to a server for later selection as an animation routine. In some embodiments the game console may determine user or game player motions, for example using an imaging device, with the user or game player motions then mapped to pre-existing animation motions of a game character, with the mapped motions being available as a selectable animation routine. The mapping may be performed by the game controller in some embodiments, but in many embodiments information of the motions is transmitted to a server. The server may thereafter perform a mapping of the motions to motions of a game character.

Similarly, in some embodiments a user or game player may create an audio file, for example using a microphone coupled to a game unit performing audio recording functions, or otherwise provide audio information, for example in the form of an audio file, to the game unit. The audio information may then be selectable as accompanying audio for an animation routine.

In block 413 the process commands display of an indication of available animation routines, and in some embodiments an indication of available accompanying audio. In block 415 the process receives a selection of one of the available animation routines, and in some embodiments accompanying audio, for example by way of an input device operated by a game player. In block 415 the process stores, for example in memory, an indication of the selected animation routine, and in some embodiment an indication of the selected accompanying audio. The process thereafter returns.

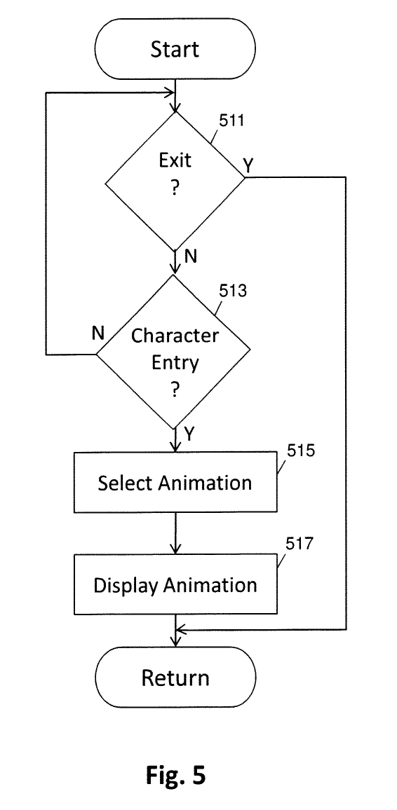

FIG. 5 is a flowchart of a process for displaying a selected animation routine for a character during game play. The process of FIG. 5 displays the selected animation routine upon entry of a character into a game. The process of FIG. 5 may be performed, for example, by the game console of FIG. 1 or the processor, in conjunction with associated circuitry, of FIG. 2.

In block 511 the process determines if the process should exit. The process should exit, for example, if game play ends or if other processing by for example a processor should occur. In various embodiments, however, the effects provided by block 511 may occur in a variety of other manners. For example, portions of the processing of FIG. 5 may generally be called by another process when a character enters, or an exception may cause portions of the processing of FIG. 5 to execute when an input or other event occurs which indicates that portions of the processing of FIG. 5 may occur. The process returns if the process should exit, otherwise the process continues to block 513

In block 513 the process determines if a character is entering game play. A character may enter game play, for example, if the process receives information that a character figure has been read by a reader capable of reading character related information, for example in embodiments which utilizes an RFID reader and toy figures with RFID transmitters. In some embodiments a game player input, provided for example by a game controller, may indicate character entry into a game. The process returns to block 511 if a character is not entering game play, otherwise, if a character is entering game play, the process continues to block 515.

In block 515 the process selects an animation routine for use with the character entering game play, and in some embodiments accompanying audio. The selection of the animation routine, and in some embodiment accompanying audio, may simply be performed by accessing memory indicating which animation routine to use, with processing for determining an animation routine performed by a process, for example, as discussed with respect to FIG. 4.

In block 517 the process commands display of the animation routine for the character, and in some embodiments commands generation of sound of the accompanying audio. Commanding display of the animation routine in most embodiments includes commanding display of the character in a sequence of positions over several seconds. The sequence of positions may result in display of the character performing a dance, for example. The sequence of positions may result in display of the character making a predefined gesture or set of gestures, as an alternative example. In some embodiments in block 517 the process also displays the animation routine for the character, and in some embodiments generates the sound of the accompanying audio.

The process thereafter returns.

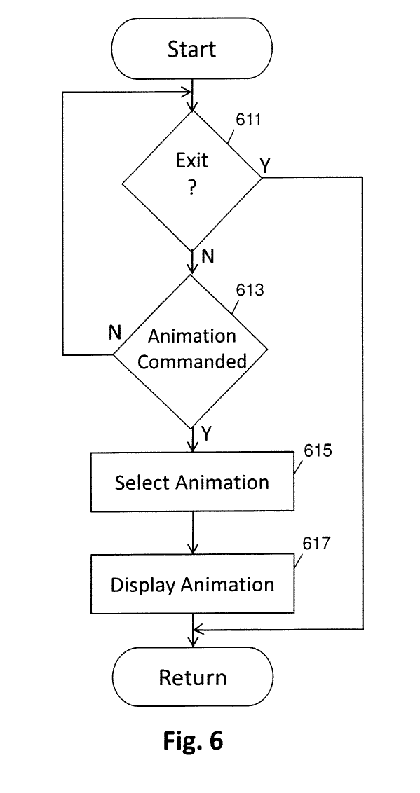

FIG. 6 is a flowchart of a further process for displaying a selected animation routine for a character during game play. The process of FIG. 6 displays the selected animation routine upon receipt of a command to display the selected animation. The process of FIG. 6 may be performed, for example, by the game console of FIG. 1 or the processor, in conjunction with associated circuitry, of FIG. 2.

In block 611 the process determines if the process should exit. The process should exit, for example, if game play ends or if other processing by for example a processor should occur. As discussed with respect to block 511 of the process of FIG. 5, however, in various embodiments the effects provided by block 611 may occur in a variety of other manners, and the comments regarding block 511 of the process of FIG. 5 apply equally to the process of FIG. 6. The process returns if the process should exit, otherwise the process continues to block 613.

In block 613 the process determines lines if performance of an animation routine for a character is commanded. Performance of the animation routine for the character may be commanded, for example, by receipt of a user input indicating the animation routine should be performed by the character. The user input may be provided, for example, by way of an input device of a game controller. The process returns to block 611 if performance of the animation routine for the character is not commanded, otherwise, if performance of the animation routine for the character is commanded, the process continues to block 615.

In block 615 the process selects an animation routine, and in some embodiments accompanying audio, for use with the character. The selection of the animation routine, and in some embodiments accompanying audio, may simply be performed by accessing memory indicating which animation routine to use, with processing for determining an animation routine performed by a process performing, for example, as discussed with respect to the process of FIG. 4.

In block 617 the process commands display of the animation routine for the character, and in some embodiments commands generation of sound of the accompanying audio. Commanding display of the animation routine in most embodiments includes commanding display of the character in a sequence of positions over several seconds. The sequence of positions may result in display of the character performing a dance, for example. The sequence of positions may result in display of the character making a predefined gesture or set of gestures, as an alternative example. In some embodiments in block 617 the process also displays the animation routine for the character, and in some embodiments generates the sound of the accompanying audio.

The process thereafter returns.

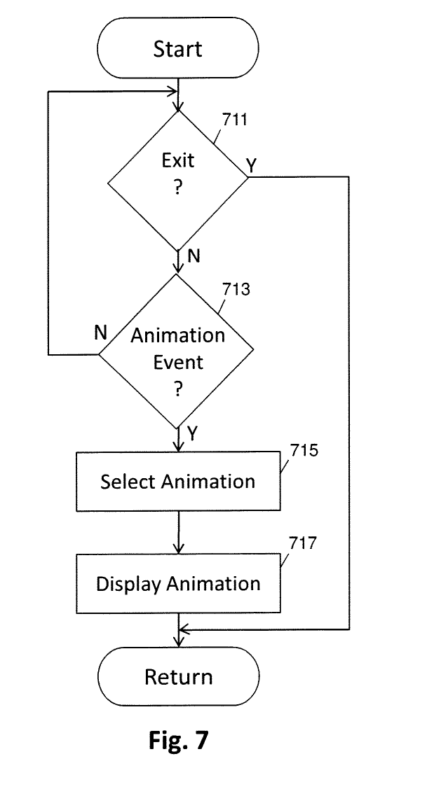

FIG. 7 is a flowchart of a further process for displaying a selected animation routine for a character during game play. The process of FIG. 7 displays the selected animation routine upon occurrence of a predefined game event. The process of FIG. 7 may be performed, for example, by the game console of FIG. 1 or the processor, in conjunction with associated circuitry, of FIG. 2.

In block 711 the process determines if the process should exit. The process should exit, for example, if game play ends or if other processing by for example a processor should occur. As discussed with respect to block 511 of the process of FIG. 5, however, in various embodiments the effects provided by block 711 may occur in a variety of other manners, and the comments regarding block 511 of the process of FIG. 5 apply equally to the process of FIG. 7. The process returns if the process should exit, otherwise the process continues to block 713.

In block 713 the process determines if a predefined game event which should result in a game character performing an animation routine has occurred. In some embodiments the predefined game event is the occurrence of a game character winning a battle with another game entity or being victorious over a game adversary. In some embodiments the predefined game event is the game character obtaining a particular game item. In some embodiments the predefined game event is the character eating a particular food, or performing some other action. In some embodiments the predefined game event is the game character advancing a level or reaching a particular level or game score. In some embodiments the predefined game event is a combination of some or all of these occurrences. The process returns to block 711 if the predefined game event has not occurred, otherwise the process continues to block 715.

In block 715 the process selects an animation routine, and in some embodiments accompanying audio, for use with the character. The selection of the animation routine may simply be performed by accessing memory indicating which animation routine to use, with processing for determining an animation routine performed by a process performing, for example, as discussed with respect to the process of FIG. 4.

In block 717 the process commands display of the animation routine for the character, and in some embodiments commands generation of sound of the accompanying audio. Commanding display of the animation routine in most embodiments includes commanding display of the character in a sequence of positions over several seconds. The sequence of positions may result in display of the character performing a dance, for example. The sequence of positions may result in display of the character making a predefined gesture or set of gestures, as an alternative example. In some embodiments in block 617 the process also displays the animation routine for the character, and in some embodiments generates the sound of the accompanying audio.

The process thereafter returns.

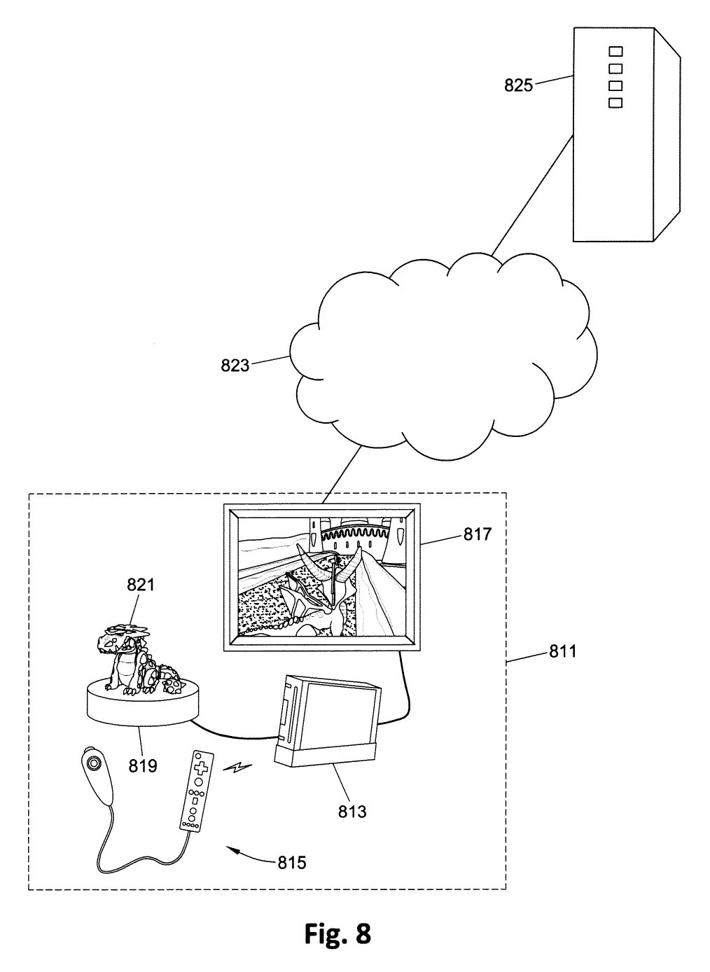

FIG. 8 is a block diagram of a network useful in providing animation routines, and in some embodiments accompanying audio. A game player system 811 is a recipient of the animation routines. In some embodiments, and as illustrated in FIG. 8, the game player system includes a game console 813 for performing game processing, a game controller 815 for a user to provide game play input commands to the game console, and a display 817 for displaying game play action as commanded by the game console. In various embodiments the game player system may instead be a handheld game device or other handheld device (for example a cell phone or tablet), a personal computer, whether in desktop, laptop, or netbook form, or, considering that the capabilities of the above mentioned devices may be approaching one another, some combination in part or in whole of such devices. Also shown in FIG. 8, a reader device 819 is coupled to the game console, with a toy figure 821 representative of a game character on the reader device. Some embodiments may not include either or both of the reader device and the toy figure. The reader device may be, for example, an RFID reader, with the toy figure including an RFID tag or other RFID readable device within on the toy figure. Alternatively, the reader device may be an imaging device, a bar code reader, or other reader device.

The game player system is coupled by way of a network 823 to a server 825. In many embodiments the server is at a remote location from the game player system, and the network comprises the Internet, with possibly multiple computers and data communication lines used in coupling the game player system and the server, as well as routers and a variety of other devices commonly coupled to or forming part of the network infrastructure. In many embodiments the server may actually comprise multiple servers, each performing part of the operations that may be performed by the server, and many servers may similarly be provided in parallel to provide for increased processing and throughput capabilities.

The server is configured, generally by one or more processors configured by program instructions, to transmit animation routine information for game characters over the network for provision to the game player system. The animation routine information is generally stored in memory of or accessible to the server, with the server recalling or reading the information and transmitting the information as appropriate.

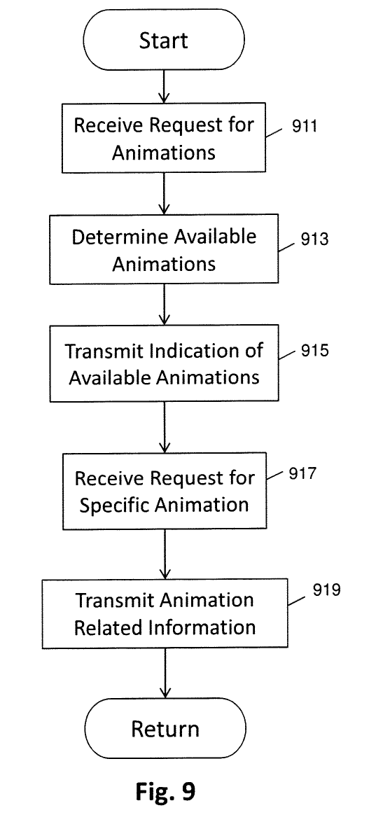

FIG. 9 is a flowchart of a process for providing animation routine information. The process of FIG. 9 may be performed by the server of FIG. 8 in some embodiments.

In block 911 the process receives a request for at least one animation routine, and/or in some embodiments a request for audio to accompany an animation routine. In some embodiments the request simply is a request for animation routines, with information of the request for example including an indication of a request for animation routines and additional information normally provided with communications between computer units, for example an identification of the requesting computer unit. In some embodiments the request additionally includes information indicating a particular character for which the animation routine is intended. In various embodiments the request may also indicate information regarding the status of the game character, for example a level of the game character, or items associated with the game character, such as items in the control of the game character or worn by the game character, which in some embodiments may be also considered as included in the status of the game character.

In block 913 the process determines available animation routines, and/or in some embodiments accompanying audio. The available animation routines, or accompanying audio, may be any animation routines, or accompanying audio, in existence in some embodiments. In many embodiments, however, the animation routines, and/or accompanying audio, are specific to a particular character, and the available animation routines are those that are in existence for the particular character. Similarly, in some embodiments the accompanying audio may be specific to a particular character and/or particular animation routine. In some embodiments only specific animation routines are available at given time, although additional animation routines may be in existence.

In block 915 the process transmits an indication of the available animation routines, and in some embodiments available accompanying audio. In block 917 the process receives a request for a specific animation routine of the transmitted available animation routines, and in some embodiments specific accompanying audio.

In block 919 the process transmits information for the specific animation routine, and in some embodiments information for the specific accompanying audio. In many embodiments the information for the specific animation routine includes data sufficient for the game player system, executing game software, to display the animation routine. In some embodiments, however, the information for the specific animation routine includes data, for example in the form of a key, to allow the game software executing on the game player system to access data for the specific animation routine present, for example, in the game software, or otherwise in memory of the game player system.

The process thereafter returns.

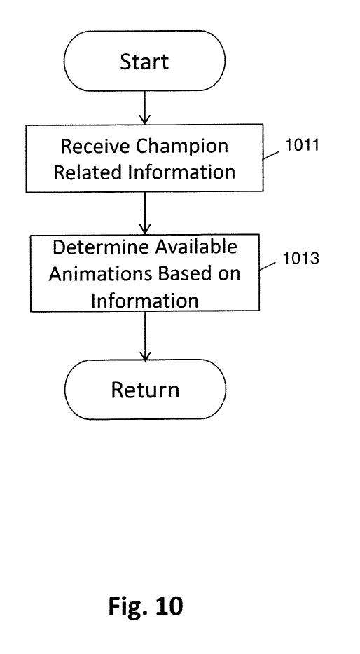

FIG. 10 is a flowchart of a process for determining available animation routines. The process of FIG. 9 may be performed by the server of FIG. 8 in some embodiments. The process may also be performed to accomplish the functions of block 913 of the process of FIG. 9.

In block 1011 the process receives game character related information. The game character related information includes, in various embodiments, an identification of the game character, information regarding a level of the game character, information regarding items owned or worn by the game character, or other game character related information. In some embodiments, the game character related information may also include an identification of an owner of the game character or a game system type on which a game including the game character has been played.

In block 1013 the process determines available animation routines based on the game character related information. In some embodiments the process does this by comparing the game character related information to animation routine availability related information. For example, in some embodiments an animation routine is only available for a specific champion, and in some embodiments only available for specific champions at or beyond a specified level. In some embodiments an animation routine may only be available if a game character is wearing a specific item, or has in its possession some other specific item.

The process thereafter returns.

Aspects of the invention provide for animation routines for game characters. Although aspects of the invention have been described with respect to various specific embodiments, it should be recognized that the invention comprises the novel and non-obvious claims supported by this disclosure.

1. A computer implemented method of providing user selectable animation routines for use in video game play, comprising:
receiving, over a data network, video game character related information regarding a video game character played by a game player and game player input;
determining available animation routines based on the video game character related information, at least some of the available animation routines being based on the game player input; and
transmitting, over the data network, information of at least one of the available animation routines.

2. The method of claim 1 wherein the video game character related information includes an identification of the video game character.

3. The method of claim 2 wherein determining available animation routines based on the video game character related information comprises determining available animation routines for the identified video game character.

4. The method of claim 1 wherein the video game character related information includes a level of the video game character.

5. The method of claim 4 wherein determining available animation routines based on the video game character related information comprises determining available animation routines for a video game character at or above the level of the video game character

6. The method of claim 1 wherein the video game character related information includes information regarding an item worn by the video game character.

7. The method of claim 6 wherein determining available animation routines based on the video game character related information comprises determining available animation routines for a video game character wearing the item.

8. The method of claim 1 further comprising transmitting, over the data network, information regarding the available animation routines.

9. The method of claim 8 further comprising receiving, over the data network, an indication of a selected animation routine, the selected animation routine being one of the available animation routines.

10. The method of claim 9 wherein the at least one of the available animation routines is the selected animation routine.

11. A non-transitory machine readable media for a video game, the machine readable media including program instructions for execution by at least one processor, the program instructions including program instructions for:
providing for video game play relating to at least one game character;
transmitting a request for an animation routine for the game character;
storing received information of the animation routine for the game character; and
commanding display of the animation routine for the game character in response to an occurrence of a predefined game event.

12. The non-transitory machine readable media of claim 11, wherein the program instructions for commanding display of the animation routine for the game character comprises program instructions for commanding display of the animation routine for the game character upon entry of the game character into video game play.

13. The non-transitory machine readable media of claim 11, wherein the program instructions for commanding display of the animation routine for the game character comprises program instructions for commanding display of the animation routine for the game character upon at least one predefined game event.

14. The non-transitory machine readable media of claim 13, wherein the at least one predefined game event comprises an advancement in level of the game character

15. The non-transitory machine readable media of claim 13, wherein the at least one predefined game event comprises a victory by the game character over an adversary.

16. The non-transitory machine readable media of claim 11, wherein the program instructions for commanding display of the animation routine for the game character comprises program instructions for commanding display of the animation routine for the game character upon receipt of a game player input indicative of a command to display the animation routine for the game character.

17. The non-transitory machine readable media of claim 11, wherein the request for an animation routine for the game character includes information relating to the game character.

18. The non-transitory machine readable media of claim 17 wherein the information relating to the game character includes a level of the game character.

19. The non-transitory machine readable media of claim 17, wherein the program instructions further include program instructions for receiving information relating to the game character from a toy figure including machine readable information relating to the game character.

20. The non-transitory machine readable media of claim 19, wherein the information relating to the game character comprise at least some of the machine readable information relating to the game character of the toy figure.
